(19) United States
(12) Patent Application Publication
(10) Pub. No.: US 2026/0296534 A1
(43) Pub. Date: Oct. 1, 2026

(54) VEHICLE DRIVING ASSISTANCE APPARATUS, VEHICLE DRIVING ASSISTANCE METHOD, AND STORAGE MEDIUM STORING VEHICLE DRIVING ASSISTANCE PROGRAM

(71) Applicant: TOYOTA JIDOSHA KABUSHIKI KAISHA, Aichi (JP)

(72) Inventor: Takeshi HAMAGUCHI, Seto-shi (JP)

(21) Appl. No.: 19/568,796

(22) Filed: Mar. 17, 2026

(30) Foreign Application Priority Data
Mar. 26, 2025 (JP) 2025-051576

(51) Int. Cl. B62D 6/00

(52) U.S. Cl. CPC B62D 6/00

(57) ABSTRACT

A vehicle driving assistance apparatus controls a steering reaction force given to a steering operation performed by an operator of a host vehicle. The apparatus detects a cant value representing a magnitude of a cant provided on a host vehicle traveling road that is a road on which the host vehicle is traveling, and detect a current-location curvature that is a curvature of the host vehicle traveling road. Further, the apparatus performs correction of the steering reaction less than a predetermined curvature threshold. On the other hand, the apparatus does not perform the correction of the steering reaction force based on the cant value when the current-location curvature is greater than the predetermined curvature threshold.

### CROSS-REFERENCE TO RELATED APPLICATIONS

This application claims priority to Japanese patent application No. JP 2025-051576 filed on Mar. 26, 2025, the content of which is hereby incorporated by reference in its entirety.

### BACKGROUND

### Field

The present invention relates to a vehicle driving assistance apparatus, a vehicle driving assistance method, and a computer readable non-transitory storage medium storing a vehicle driving assistance program.

### Description of the Related Art

There is known a vehicle driving assistance apparatus that assists a steering operation performed by a driver of a host vehicle. As such a vehicle driving assistance apparatus, there is also known a vehicle driving assistance apparatus that assists a steering operation in consideration of a magnitude of a cant provided on a road (see, for example, Japanese Unexamined Patent Application Publication No. 2022-038983).

For example, in a situation where an acceleration rate sensor used to detect a lateral acceleration rate of the host vehicle is mounted on the host vehicle, an acceleration rate detected by the acceleration rate sensor becomes large when the host vehicle is traveling on a road provided with a cant. Therefore, the magnitude of the cant can be detected based on the acceleration rate detected by the acceleration rate sensor.

However, even when the host vehicle is traveling on a road on which a cant is not provided, if the road is a curved road, the acceleration rate detected by the acceleration rate sensor becomes large. At this time, when the magnitude of the cant is detected based on the acceleration rate detected by the acceleration rate sensor and the steering operation is assisted based on the detected magnitude of the cant, there is a possibility that inappropriate assistance is performed.

### SUMMARY

An object of the present invention is to provide a vehicle driving assistance apparatus, a vehicle driving assistance method, and a computer readable non-transitory storage medium storing a vehicle driving assistance program that can appropriately perform steering assistance based on a magnitude of a cant provided on a road.

A vehicle driving assistance apparatus according to the present invention comprises an electronic control unit that controls a steering reaction force given to a steering operation performed by an operator of a host vehicle. The electronic control unit is configured to detect a cant value representing a magnitude of a cant provided on a host vehicle traveling road that is a road on which the host vehicle is traveling, and detect a current-location curvature that is a curvature of the host vehicle traveling road. Further, the electronic control unit is configured to perform correction of the steering reaction force based on the cant value when the current-location curvature is equal to or less than a predetermined curvature threshold. Furthermore, the electronic control unit is configured to not perform the correction of the steering reaction force based on the cant value when the current-location curvature is greater than the predetermined curvature threshold.

For example, in a situation where the acceleration rate sensor used to detect a lateral acceleration rate of the host vehicle is mounted on the host vehicle, the acceleration rate detected by the acceleration rate sensor becomes large when the host vehicle is traveling on a road provided with a cant. Therefore, the magnitude of the cant can be detected based on the acceleration rate detected by the acceleration rate sensor.

However, even when the host vehicle is traveling on a road on which a cant is not provided, if the road is a curved road, the acceleration rate detected by the acceleration rate sensor becomes large. At this time, when the magnitude of the cant is detected based on the acceleration rate detected by the acceleration rate sensor and the steering operation is assisted based on the detected magnitude of the cant, there is a possibility that inappropriate assistance is performed.

According to the vehicle driving assistance apparatus according to the present invention, when the current-location curvature is greater than the predetermined curvature threshold, the correction of the steering reaction force based on the cant value is not performed. Therefore, the steering assistance based on the magnitude of the cant provided on the road can be appropriately performed.

It should be noted that in the vehicle driving assistance apparatus according to an aspect of the present invention, the host vehicle may be equipped with an acceleration rate sensor used to detect a lateral acceleration rate of the host vehicle. In this aspect, the electronic control unit may be configured to detect the cant value based on the acceleration rate detected by the acceleration rate sensor.

As described above, when the magnitude of the cant is detected based on the acceleration rate detected by the acceleration rate sensor and the steering operation is assisted based on the detected magnitude of the cant, there are situations in which inappropriate assistance is performed. In the vehicle driving assistance apparatus according to this aspect of the present invention, the host vehicle is equipped with the acceleration rate sensor used to detect a lateral acceleration rate of the host vehicle, and the cant value is detected based on the acceleration rate detected by the acceleration rate sensor. However, according to the vehicle driving assistance apparatus according to this aspect of the present invention, when the current-location curvature is greater than the predetermined curvature threshold, the correction of the steering reaction force based on the cant value is not performed. Therefore, the steering assistance based on the magnitude of the cant provided on the road can be appropriately performed.

Further, a vehicle driving assistance method according to the present invention is a method of controlling a steering reaction force given to a steering operation performed by an operator of a host vehicle. The vehicle driving assistance method comprises a step of detecting a cant value representing a magnitude of a cant provided on a host vehicle traveling road that is a road on which the host vehicle is traveling, and detecting a current-location curvature that is a curvature of the host vehicle traveling road. Further, the vehicle driving assistance method comprises a step of performing correction of the steering reaction force based on the cant value when the current-location curvature is equal to or less than a predetermined curvature threshold. Furthermore, the vehicle driving assistance method comprises a step of not performing the correction of the steering reaction force based on the cant value when the current-location curvature is greater than the predetermined curvature threshold.

According to the vehicle driving assistance method according to the present invention, for the same reason as described above, the steering assistance based on the magnitude of the cant provided on the road can be appropriately performed.

Furthermore, a computer-readable non-transitory storage medium according to the present invention stores a vehicle driving assistance program which controls a steering reaction force given to a steering operation performed by an operator of a host vehicle. The vehicle driving assistance program is configured to detect a cant value representing a magnitude of a cant provided on a host vehicle traveling road that is a road on which the host vehicle is traveling, and detect a current-location curvature that is a curvature of the host vehicle traveling road. Further, the vehicle driving assistance program is configured to perform correction of the steering reaction force based on the cant value when the current-location curvature is equal to or less than a predetermined curvature threshold. On the other hand, the vehicle driving assistance program is configured to not perform the correction of the steering reaction force based on the cant value when the current-location curvature is greater than the predetermined curvature threshold.

According to the vehicle driving assistance program according to the present invention, for the same reason as described above, the steering assistance based on the magnitude of the cant provided on the road can be appropriately performed.

Constituent elements of the present invention are not limited to the embodiments of the present invention described below with reference to the drawings. Other objects, other features, and attendant advantages of the present invention will be readily understood from the description of the embodiments of the present invention.

### BRIEF DESCRIPTION OF THE DRAWINGS

FIG. 1 is a diagram showing a vehicle driving assistance apparatus according to an embodiment of the present invention.

FIG. 2 is a flowchart showing a routine executed by the vehicle driving assistance apparatus according to a modified example of the embodiment of the present invention.

FIG. 3 is a flowchart showing a routine executed by the vehicle driving assistance apparatus according to a modified example of the embodiment of the present invention.

FIG. 4 is a diagram showing a situation in which a host vehicle enters a curved road.

FIG. 5 is a diagram for explaining a determination method of a stress.

FIG. 6 is a diagram showing a cant.

FIG. 7 is a diagram for explaining a method of acquiring a cant correction steering angle.

### DETAILED DESCRIPTION

Hereinafter, a vehicle driving assistance apparatus, a vehicle driving assistance method, and a computer readable non-transitory storage medium storing a vehicle driving assistance program according to an embodiment of the present invention will be described with reference to the drawings.

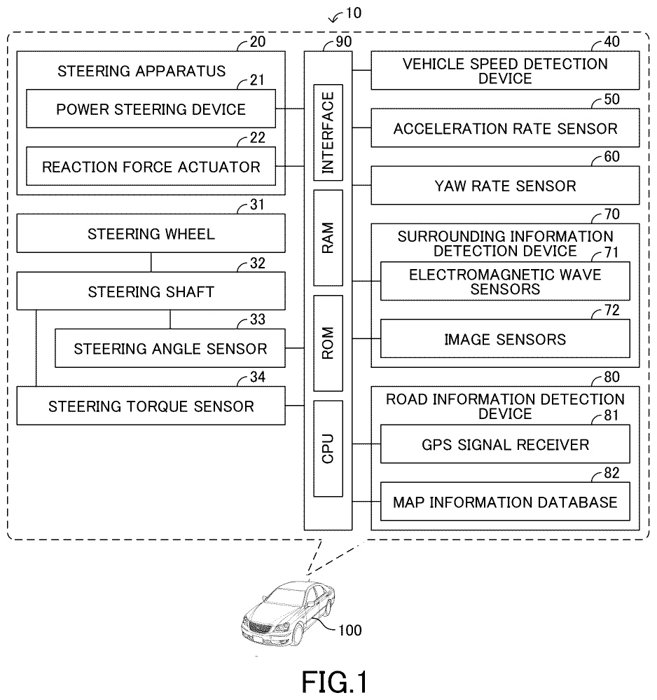

A vehicle driving assistance apparatus 10 according to the embodiment of the present invention is shown in FIG. 1. The vehicle driving assistance apparatus 10 is mounted on a host vehicle 100. Hereinafter, the vehicle driving assistance apparatus 10 will be described by taking, as an example, a case in which an operator of the host vehicle 100 is a driver of the host vehicle 100 (that is, a person who rides in the host vehicle 100 and drives the host vehicle 100). However, the operator of the host vehicle 100 may be a remote operator of the host vehicle 100 (that is, a person who remotely drives the host vehicle 100 without riding in the host vehicle 100). It should be noted that, in the following description, the driver of the host vehicle 100 may be simply referred to as a “driver”.

As shown in FIG. 1, the vehicle driving assistance apparatus 10 includes an ECU (electronic control unit) 90 as a control device. The ECU 90 includes a microcomputer as a main component. The microcomputer includes a CPU, a computer-readable storage medium, and an interface, and the like. The storage medium includes a ROM, a RAM, a non-volatile memory, and the like. The CPU is configured to implement various functions by executing instructions, programs, or routines stored in the storage medium. In particular, in this example, the vehicle driving assistance apparatus 10 stores, in the storage medium, programs for implementing various controls executed by the vehicle driving assistance apparatus 10.

It should be noted that, in this example, the vehicle driving assistance apparatus 10 includes only one ECU 90. However, the vehicle driving assistance apparatus 10 may include a plurality of ECUs and be configured such that the functions of the vehicle driving assistance apparatus 10 described below are shared and executed by the respective ECUs.

Further, the vehicle driving assistance apparatus 10 may be configured such that programs stored in the storage medium can be updated (upgraded) by wireless communication (for example, internet communication) with external devices.

Further, the vehicle driving assistance apparatus 10 is applicable not only to a vehicle that is driven by manual driving by an operator, but also to a vehicle that is driven by automatic driving.

As shown in FIG. 1, the host vehicle 100 is equipped with a steering apparatus 20, a steering wheel 31, a steering shaft 32, a steering angle sensor 33, a steering torque sensor 34, a vehicle speed detection device 40, an acceleration rate sensor 50, a yaw rate sensor 60, a surrounding information detection device 70, and a road information detection device 80.

The steering apparatus 20 is an apparatus for steering the host vehicle 100. In this example, the steering apparatus 20 includes a power steering device 21 and a reaction force actuator 22. The power steering device 21 outputs a steering torque or a steering force for steering the host vehicle 100. The reaction force actuator 22 applies a steering reaction force to the steering wheel 31. The steering reaction force is a reaction force that resists a force applied to the steering wheel 31 to rotate the steering wheel 31.

The power steering device 21 and the reaction force actuator 22 are electrically connected to the ECU 90. The vehicle driving assistance apparatus 10 controls a steering torque output from the power steering device 21 by controlling an operation of the power steering device 21. Further, the vehicle driving assistance apparatus 10 controls the steering reaction force by controlling an operation of the reaction force actuator 22.

The steering wheel 31 is operated by the driver to steer the host vehicle 100. The steering wheel 31 is connected to the steering shaft 32. The driver can rotate the steering shaft 32 by performing a rotation operation on the steering wheel 31.

The steering angle sensor 33 is used to detect a rotation angle of the steering shaft 32 with respect to a neutral position. The steering angle sensor 33 is electrically connected to the ECU 90. The vehicle driving assistance apparatus 10 acquires the rotation angle of the steering shaft 32 as an actual steering angle θact by means of the steering angle sensor 33.

The steering torque sensor 34 is used to detect a torque input to the steering shaft 32 by the driver via the steering wheel 31. The steering torque sensor 34 is electrically connected to the ECU 90. The vehicle driving assistance apparatus 10 acquires the torque input to the steering shaft 32 by the driver via the steering wheel 31 as a driver input torque tqd by means of the steering torque sensor 34.

The vehicle driving assistance apparatus 10 acquires a required steering torque TQr based on the actual steering angle θact, the driver input torque TQd, and a host vehicle speed V. The host vehicle speed V is a traveling speed of the host vehicle 100. Further, the vehicle driving assistance apparatus 10 controls an operation of the steering apparatus 20 such that a steering torque corresponding to the acquired required steering torque TQr is output from the steering apparatus 20.

The vehicle speed detection device 40 is used to detect a traveling speed of the host vehicle 100. The vehicle speed detection device 40 includes, for example, wheel rotation speed sensors provided on respective wheels of the host vehicle 100. The vehicle speed detection device 40 is electrically connected to the ECU 90. The vehicle driving assistance apparatus 10 acquires the traveling speed of the host vehicle 100 as the host vehicle speed V by means of the vehicle speed detection device 40.

The acceleration rate sensor 50 is used to detect a lateral acceleration rate of the host vehicle 100. The acceleration rate sensor 50 is electrically connected to the ECU 90. The vehicle driving assistance apparatus 10 acquires the lateral acceleration rate of the host vehicle 100 as a lateral acceleration rate Gy by means of the acceleration rate sensor 50.

The yaw rate sensor 60 is used to detect a yaw rate of the host vehicle 100. The yaw rate sensor 60 is electrically connected to the ECU 90. The vehicle driving assistance apparatus 10 acquires the yaw rate of the host vehicle 100 as an actual yaw rate yact by means of the yaw rate sensor 60.

The surrounding information detection device 70 is used to detect information on surroundings of the host vehicle 100. In this example, the surrounding information detection device 70 includes a plurality of electromagnetic wave sensors 71 and a plurality of image sensors 72. The electromagnetic wave sensors 71 are, for example, radar sensors such as millimeter-wave radars. Further, the image sensors 72 are, for example, camera sensors. The electromagnetic wave sensors 71 and the image sensors 72 are electrically connected to the ECU 90. The vehicle driving assistance apparatus 10 acquires information (object information IO) on objects present around the host vehicle 100 as surrounding information IS by means of the electromagnetic wave sensors 71. Further, the vehicle driving assistance apparatus 10 acquires image information IC on surroundings of the host vehicle 100 as the surrounding information IS by means of the image sensors 72.

The road information detection device 80 includes a GPS signal receiver 81 and a map information database 82.

The GPS signal receiver 81 receives GPS signals. The GPS signal receiver 81 is electrically connected to the ECU 90. The vehicle driving assistance apparatus 10 receives GPS signals via the GPS signal receiver 81. The vehicle driving assistance apparatus 10 acquires a current position of the host vehicle 100 based on the GPS signals.

The map information database 82 stores map information IM. In particular, the map information database 82 stores information on a curve radius or a curvature of a road. The map information database 82 is electrically connected to the ECU 90. The vehicle driving assistance apparatus 10 acquires road information IR from the current position of the host vehicle 100 and the map information IM. The road information IR is information on a host vehicle traveling road RD on which the host vehicle 100 is traveling.

### <Operation of Vehicle Driving Assistance Apparatus>

Next, an operation of the vehicle driving assistance apparatus 10 will be described.

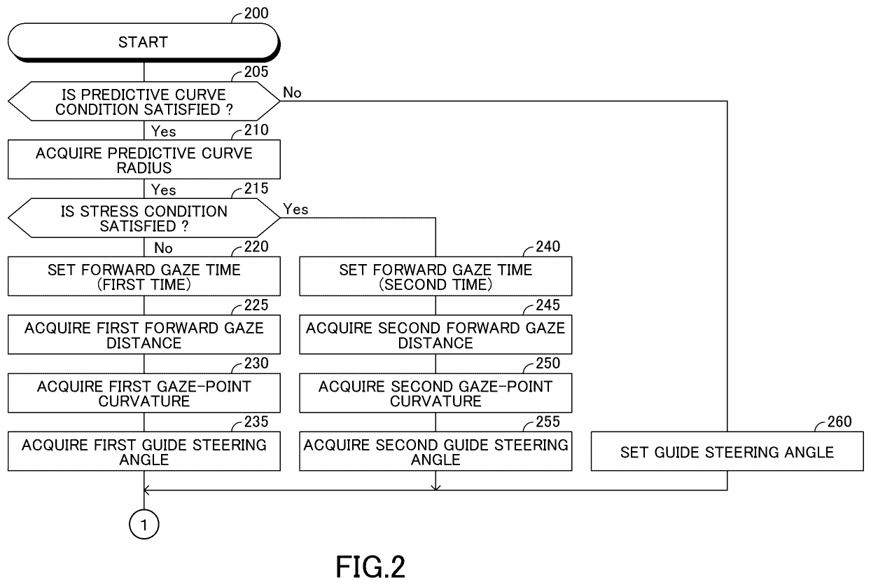

The vehicle driving assistance apparatus 10 is configured to control a steering reaction force given to a steering operation performed by the driver. For this purpose, the vehicle driving assistance apparatus 10 executes a routine shown in FIG. 2 at predetermined time intervals. Therefore, at a predetermined timing, the vehicle driving assistance apparatus 10 starts a process from a step S200 shown in FIG. 2. Then, the vehicle driving assistance apparatus 10 proceeds with the process to a step S205 to determine whether or not a predictive curve condition C1 is satisfied.

The predictive curve condition C1 is satisfied when it is predicted that the host vehicle 100 enters a curved road. The vehicle driving assistance apparatus 10 predicts that the host vehicle 100 enters the curved road based on the image information IC and/or the road information IR.

When the vehicle driving assistance apparatus 10 determines “Yes” at the step S205, the vehicle driving assistance apparatus 10 proceeds with the process to a step S210 to acquire a predictive curve radius R.

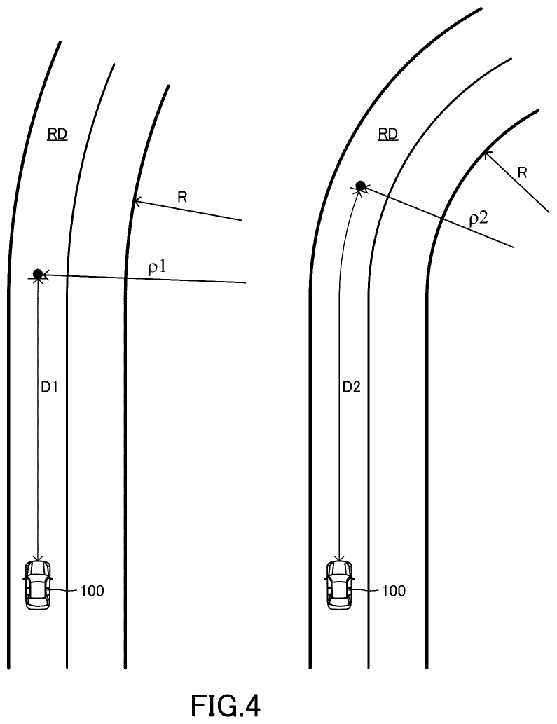

As shown in FIG. 4, the predictive curve radius R is a minimum radius of curvature of an entry-predicted curved road CR. The vehicle driving assistance apparatus 10 acquires the predictive curve radius R based on the road information IR and/or the image information IC. It should be noted that the entry-predicted curved road CR is a curved road that the host vehicle 100 is predicted to enter at the step S205.

Next, the vehicle driving assistance apparatus 10 proceeds with the process to a step S215 to determine whether or not a stress condition C2 is satisfied.

The stress condition C2 is satisfied when there is a stress. On the other hand, the stress condition C2 is not satisfied when there is no stress.

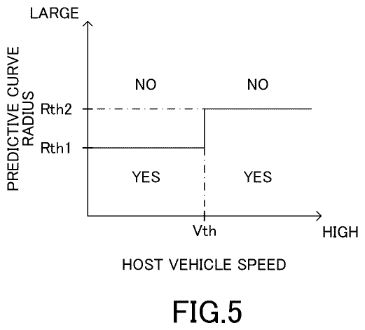

More specifically, as shown in FIG. 5, the stress condition C2 is satisfied when the host vehicle speed V is within a range lower than a predetermined vehicle speed Vth and the predictive curve radius R is equal to or less than a first radius Rth1. Further, the stress condition C2 is satisfied when the host vehicle speed V is within a range equal to or greater than the predetermined vehicle speed Vth and the predictive curve radius R is equal to or less than a second radius Rth2. It should be noted that the second radius Rth2 is set to a value greater than the first radius Rth1.

On the other hand, the stress condition C2 is not satisfied when the host vehicle speed V is within a range lower than the predetermined vehicle speed Vth and the predictive curve radius R is greater than the first radius Rth1. Further, the stress condition C2 is not satisfied when the host vehicle speed V is within a range equal to or greater than the predetermined vehicle speed Vth and the predictive curve radius R is greater than the second radius Rth2.

It should be noted that, in this example, the stress condition C2 is a condition based on both the host vehicle speed V and the predictive curve radius R, but may be a condition based only on the predictive curve radius R.

When the vehicle driving assistance apparatus 10 determines “No” at the step S215, the vehicle driving assistance apparatus 10 proceeds with the process to a step S220 to set a first time T1 as a forward gaze time T. The forward gaze time T is a smaller value when the stress condition C2 is not satisfied than when the stress condition C2 is satisfied.

Next, the vehicle driving assistance apparatus 10 proceeds with the process to a step S225 to acquire a first forward gaze distance D1. Here, as shown in the following equation 1, the vehicle driving assistance apparatus 10 acquires a value obtained by multiplying the forward gaze time T (that is, the first time T1) set at the step S220 by the host vehicle speed V as the first forward gaze distance D1.

$$D 1 = V \cdot T 1 \qquad ( 1 )$$

Next, the vehicle driving assistance apparatus 10 proceeds with the process to a step S230 to acquire a first gaze-point curvature ρ1. As shown in FIG. 4, the first gaze-point curvature ρ1 is a curvature of the host vehicle traveling road RD at a position ahead of the host vehicle 100 by the first forward gaze distance D1 acquired at the step S225. That is, the first gaze-point curvature ρ1 is a curvature of the host vehicle traveling road RD at a position ahead of the host vehicle 100 that is estimated to be gazed at by the driver who is in front of the entry-predicted curved road CR having the predictive curve radius R acquired at the step S210.

It should be noted that the vehicle driving assistance apparatus 10 acquires the first gaze-point curvature ρ1 based on the road information IR and/or the image information IC.

Next, the vehicle driving assistance apparatus 10 proceeds with the process to a step S235 to acquire a first guide steering angle θg1 as a guide steering angle θg. Here, the vehicle driving assistance apparatus 10 acquires the first guide steering angle θg1 in accordance with an arithmetic expression shown in the following equation 2.

$$θ g 1 = n \times K \times ( 1 + A \times {V}^{2} ) \times L \times ρ1 \qquad ( 2 )$$

In the equation 2, “n” is a gear ratio of a steering box of the host vehicle 100. Further, “K” is a coefficient (calibration value) obtained by experiments and the like such that the first guide steering angle θg1 acquired by the equation 2 is acquired as a value that can cause the host vehicle 100 to smoothly travel along the entry-predicted curved road CR. Further, “A” is a so-called stability factor of the host vehicle 100. Further, “V” is the host vehicle speed. Further, “L” is a wheelbase of the host vehicle 100. Further, “ρ1” is the first gaze-point curvature ρ1 acquired at the step S230.

Therefore, the first guide steering angle θg1 becomes larger as the first gaze-point curvature ρ1 becomes larger.

It should be noted that, when the entry-predicted curved road CR is a road curving rightward, the first guide steering angle θg1 is an angle in a clockwise direction from a neutral position of the steering wheel 31. On the other hand, when the entry-predicted curved road CR is a road curving leftward, the first guide steering angle θg1 is an angle in a counterclockwise direction from the neutral position of the steering wheel 31.

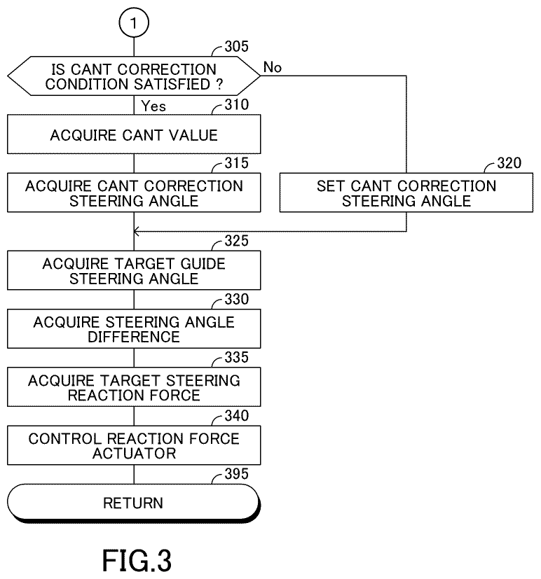

Next, the vehicle driving assistance apparatus 10 proceeds with the process to a step S305 of a routine shown in FIG. 3.

On the other hand, when the vehicle driving assistance apparatus 10 determines “Yes” at the step S215, the vehicle driving assistance apparatus 10 proceeds with the process to a step S240 to set a second time T2 as the forward gaze time T. As described above, the forward gaze time T is a smaller value when the stress condition C2 is not satisfied than when the stress condition C2 is satisfied. Therefore, the second time T2 is larger than the first time T1.

Next, the vehicle driving assistance apparatus 10 proceeds with the process to a step S245 to acquire a second forward gaze distance D2. Here, as shown in the following equation 3, the vehicle driving assistance apparatus 10 acquires a value obtained by multiplying the forward gaze time T (that is, the second time T2) set at the step S240 by the host vehicle speed V as the second forward gaze distance D2.

$$D 2 = V \cdot T 2 \qquad ( 3 )$$

It should be noted that, since the second time T2 is larger than the first time T1, when the host vehicle speed V is the same, the second forward gaze distance D2 is larger than the first forward gaze distance D1.

Next, the vehicle driving assistance apparatus 10 proceeds with the process to a step S250 to acquire a second gaze-point curvature ρ2. As shown in FIG. 4, the second gaze-point curvature ρ2 is a curvature of the host vehicle traveling road RD at a position ahead of the host vehicle 100 by the second forward gaze distance D2 acquired at the step S245. That is, the second gaze-point curvature ρ2 is a curvature of the host vehicle traveling road RD at a position ahead of the host vehicle 100 that is estimated to be gazed at by the driver who is in front of the entry-predicted curved road CR having the predictive curve radius R acquired at the step S210.

It should be noted that the vehicle driving assistance apparatus 10 acquires the second gaze-point curvature ρ2 based on the road information IR and/or the image information IC.

Next, the vehicle driving assistance apparatus 10 proceeds with the process to a step S255 to acquire a second guide steering angle θg2 as the guide steering angle θg. Here, the vehicle driving assistance apparatus 10 acquires the second guide steering angle θg2 in accordance with an arithmetic expression shown in the following equation 4.

$$θ g 2 = n \times K \times ( 1 + A \times {V}^{2} ) \times L \times ρ2 \qquad ( 4 )$$

In the equation 4, “n” is the gear ratio of the steering box of the host vehicle 100. Further, “K” is a coefficient (calibration value) obtained by experiments and the like such that the second guide steering angle θg2 acquired by the equation 4 is acquired as a value that can cause the host vehicle 100 to smoothly travel along the entry-predicted curved road CR. Further, “A” is the stability factor of the host vehicle 100. Further, “V” is the host vehicle speed. Further, “L” is the wheelbase of the host vehicle 100. Further, “ρ2” is the second gaze-point curvature ρ2 acquired at the step S250.

Therefore, the second guide steering angle θg2 becomes larger as the second gaze-point curvature ρ2 becomes larger.

It should be noted that, when the entry-predicted curved road CR is a road curving rightward, the second guide steering angle θg2 is an angle in a clockwise direction from a neutral position of the steering wheel 31. On the other hand, when the entry-predicted curved road CR is a road curving leftward, the second guide steering angle θg2 is an angle in a counterclockwise direction from the neutral position of the steering wheel 31.

Next, the vehicle driving assistance apparatus 10 proceeds with the process to the step S305 of the routine shown in FIG. 3.

Further, when the vehicle driving assistance apparatus 10 determines “No” at the step S205, the vehicle driving assistance apparatus 10 proceeds with the process to a step S260 to set the guide steering angle θg to zero. Next, the vehicle driving assistance apparatus 10 proceeds with the process to the step S305 of the routine shown in FIG. 3.

When the vehicle driving assistance apparatus 10 proceeds with the process to the step S305, the vehicle driving assistance apparatus 10 determines whether or not a cant correction condition C3 is satisfied. The cant correction condition C3 is satisfied when a current-location curvature ρnow is equal to or less than a first curvature threshold ρth1.

The current-location curvature ρnow is a curvature of the host vehicle traveling road RD. The vehicle driving assistance apparatus 10 acquires the current-location curvature ρnow based on the road information IR. However, the vehicle driving assistance apparatus 10 may be configured to acquire the current-location curvature ρnow based on the image information IC. Alternatively, when a preceding vehicle is present ahead of the host vehicle 100, the vehicle driving assistance apparatus 10 may be configured to acquire a traveling trajectory of the preceding vehicle based on the image information IC and acquire the current-location curvature ρnow based on the traveling trajectory.

As described above, the vehicle driving assistance apparatus 10 is configured to detect the current-location curvature ρnow that is a curvature of the host vehicle traveling road RD.

Further, the first curvature threshold ρth1 is set to a maximum value of the current-location curvature ρnow or a value smaller than the maximum value by a predetermined value, the maximum value being a value at which it can be determined that a cant value CV acquired as described later is caused by a cant actually provided on the host vehicle traveling road RD.

When the vehicle driving assistance apparatus 10 determines “Yes” at the step S305, the vehicle driving assistance apparatus 10 proceeds with the process to a step S310 to acquire a cant value CV.

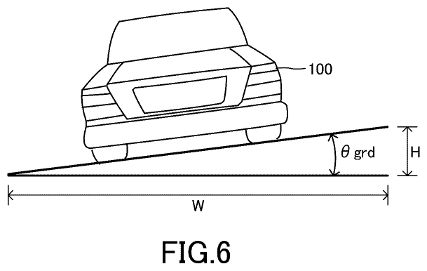

The cant value CV is a value representing a transverse slope provided on a road. For example, as shown in FIG. 6, when a cant is provided on a road, the cant value CV is represented by a value obtained by dividing a height difference H in a transverse direction of the road by a width W in the transverse direction of the road (CV=H/W). Therefore, when the width W in the transverse direction of the road is constant, the cant value CV becomes larger as the height difference H in the transverse direction of the road becomes larger. In other words, the cant value CV becomes larger as a gradient θgrd in the transverse direction of the road becomes larger.

The vehicle driving assistance apparatus 10 acquires the cant value CV based on the lateral acceleration rate Gy detected by the acceleration rate sensor 50. It should be noted that the cant value CV becomes larger as the lateral acceleration rate Gy becomes larger. Alternatively, the vehicle driving assistance apparatus 10 may be configured to acquire the cant value CV based on a yaw rate difference ΔY. The yaw rate difference ΔY is a value obtained by subtracting the actual yaw rate Yact from an estimated generated yaw rate Yest (ΔY=Yest−Yact). Further, the estimated generated yaw rate Yest is a yaw rate estimated to be generated corresponding to the actual steering angle θact at that time. The estimated generated yaw rate Yest can be acquired using a vehicle model. It should be noted that the cant value CV becomes larger as the yaw rate difference ΔY becomes larger.

As described above, the vehicle driving assistance apparatus 10 is configured to detect the cant value CV representing a magnitude of a cant provided on the host vehicle traveling road RD.

Next, the vehicle driving assistance apparatus 10 proceeds with the process to a step S315 to acquire a cant correction steering angle θc based on the cant value CV acquired at the step S310. Next, the vehicle driving assistance apparatus 10 proceeds with the process to a step S325.

It should be noted that the cant correction steering angle θc acquired at the step S315 becomes larger as the cant value CV acquired at the step S310 becomes larger.

Further, as shown in FIG. 6, when the host vehicle 100 is traveling on a left-downward cross-sloped road, the cant correction steering angle θc functions to decrease a counterclockwise steering reaction force FL and increase a clockwise steering reaction force FR. As a result, the driver can easily rotate the steering wheel 31 clockwise. It should be noted that the left-downward cross-sloped road is a road provided with a cant in which a left road edge is lower than a right road edge. Further, the counterclockwise steering reaction force FL is a steering reaction force applied to the steering wheel 31 in a counterclockwise direction. Further, the clockwise steering reaction force FR is a steering reaction force applied to the steering wheel 31 in a clockwise direction.

On the other hand, when the host vehicle 100 is traveling on a right-downward cross-sloped road, the cant correction steering angle θc functions to decrease the clockwise steering reaction force FR and increase the counterclockwise steering reaction force FL. As a result, the driver can easily rotate the steering wheel 31 counterclockwise. It should be noted that the right-downward cross-sloped road is a road provided with a cant in which a right road edge is lower than a left road edge.

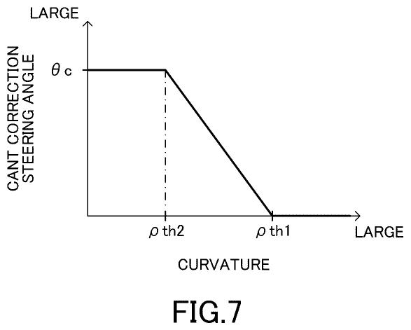

It should be noted that the vehicle driving assistance apparatus 10 may be configured to acquire the cant correction steering angle θc as follows. That is, the vehicle driving assistance apparatus 10 acquires a reference cant correction steering angle θb based on the cant value CV. Then, as shown in FIG. 7, when the current-location curvature ρnow is equal to or less than a second curvature threshold ρth2, the vehicle driving assistance apparatus 10 acquires the reference cant correction steering angle θb as the cant correction steering angle θc as it is. On the other hand, when the current-location curvature ρnow is greater than the second curvature threshold ρth2 and equal to or less than the first curvature threshold ρth1, the vehicle driving assistance apparatus 10 acquires a value smaller than the reference cant correction steering angle θb as the cant correction steering angle θc. At this time, the vehicle driving assistance apparatus 10 acquires a smaller cant correction steering angle θc as the current-location curvature ρnow becomes larger.

On the other hand, when the vehicle driving assistance apparatus 10 determines “No” at the step S305, the vehicle driving assistance apparatus 10 proceeds with the process to a step S320 to set the cant correction steering angle θc to zero. Next, the vehicle driving assistance apparatus 10 proceeds with the process to the step s325.

When the vehicle driving assistance apparatus 10 proceeds with the process to the step S325, the vehicle driving assistance apparatus 10 acquires a target guide steering angle θtgt.

Specifically, when the vehicle driving assistance apparatus 10 proceeds with the process to the step S325 via the step S235 and the step S315, the vehicle driving assistance apparatus 10 acquires, as the target guide steering angle θtgt, a value obtained by adding the cant correction steering angle θc acquired at the step S315 to the first guide steering angle θg1 acquired at the step S235 (θtgt=θg1+θc).

It should be noted that, in this case, when the entry-predicted curved road CR is a road curving rightward and the cant correction steering angle θc acquired at the step S315 corresponds to a right-downward cross-sloped road, the cant correction steering angle θc acquired at the step S315 functions such that the target guide steering angle θtgt smaller than the first guide steering angle θg1 is acquired.

That is, when the current-location curvature ρnow is equal to or less than a predetermined curvature threshold (that is, the first curvature threshold ρth1), the first guide steering angle θg1 corrected by the cant correction steering angle θc is set as the target guide steering angle θtgt. Then, the target guide steering angle θtgt is used to determine a magnitude of the steering reaction force. Therefore, when the current-location curvature ρnow is equal to or less than the predetermined curvature threshold (that is, the first curvature threshold ρth1), the vehicle driving assistance apparatus 10 performs correction of the steering reaction force based on the cant value CV.

On the other hand, when the entry-predicted curved road CR is a road curving rightward and the cant correction steering angle θc acquired at the step S315 corresponds to a left-downward cross-sloped road, the cant correction steering angle θc acquired at the step S315 functions such that the target guide steering angle θtgt larger than the first guide steering angle θg1 is acquired.

That is, when the current-location curvature ρnow is equal to or less than the predetermined curvature threshold (that is, the first curvature threshold ρth1), the first guide steering angle θg1 corrected by the cant correction steering angle θc is set as the target guide steering angle θtgt. Then, the target guide steering angle θtgt is used to determine the magnitude of the steering reaction force. Therefore, when the current-location curvature ρnow is equal to or less than the predetermined curvature threshold (that is, the first curvature threshold ρth1), the vehicle driving assistance apparatus 10 performs correction of the steering reaction force based on the cant value CV.

Further, when the entry-predicted curved road CR is a road curving leftward and the cant correction steering angle θc acquired at the step S315 corresponds to a left-downward cross-sloped road, the cant correction steering angle θc acquired at the step S315 functions such that the target guide steering angle θtgt smaller than the first guide steering angle θg1 is acquired.

That is, when the current-location curvature ρnow is equal to or less than the predetermined curvature threshold (that is, the first curvature threshold ρth1), the first guide steering angle θg1 corrected by the cant correction steering angle θc is set as the target guide steering angle θtgt. Then, the target guide steering angle θtgt is used to determine the magnitude of the steering reaction force. Therefore, when the current-location curvature ρnow is equal to or less than the predetermined curvature threshold (that is, the first curvature threshold ρth1), the vehicle driving assistance apparatus 10 performs correction of the steering reaction force based on the cant value CV.

On the other hand, when the entry-predicted curved road CR is a road curving leftward and the cant correction steering angle θc acquired at the step S315 corresponds to a right-downward cross-sloped road, the cant correction steering angle θc acquired at the step S315 functions such that the target guide steering angle θtgt larger than the first guide steering angle θg1 is acquired.

That is, when the current-location curvature ρnow is equal to or less than the predetermined curvature threshold (that is, the first curvature threshold ρth1), the first guide steering angle θg1 corrected by the cant correction steering angle θc is set as the target guide steering angle θtgt. Then, the target guide steering angle θtgt is used to determine the magnitude of the steering reaction force. Therefore, when the current-location curvature ρnow is equal to or less than the predetermined curvature threshold (that is, the first curvature threshold ρth1), the vehicle driving assistance apparatus 10 performs correction of the steering reaction force based on the cant value CV.

Further, when the vehicle driving assistance apparatus 10 proceeds with the process to the step S325 via the step S255 and the step S315, the vehicle driving assistance apparatus 10 acquires, as the target guide steering angle θtgt, a value obtained by adding the cant correction steering angle θc acquired at the step S315 to the second guide steering angle θg2 acquired at the step S255 (θtgt=θg2+θc).

It should be noted that, in this case, when the entry-predicted curved road CR is a road curving rightward and the cant correction steering angle θc acquired at the step S315 corresponds to a right-downward cross-sloped road, the cant correction steering angle θc acquired at the step S315 functions such that the target guide steering angle θtgt smaller than the second guide steering angle θg2 is acquired.

That is, when the current-location curvature ρnow is equal to or less than a predetermined curvature threshold (that is, the first curvature threshold ρth1), the second guide steering angle θg2 corrected by the cant correction steering angle θc is set as the target guide steering angle θtgt. Then, the target guide steering angle θtgt is used to determine a magnitude of the steering reaction force. Therefore, when the current-location curvature ρnow is equal to or less than the predetermined curvature threshold (that is, the first curvature threshold ρth1), the vehicle driving assistance apparatus 10 performs correction of the steering reaction force based on the cant value CV.

On the other hand, when the entry-predicted curved road CR is a road curving rightward and the cant correction steering angle θc acquired at the step S315 corresponds to a left-downward cross-sloped road, the cant correction steering angle θc acquired at the step S315 functions such that the target guide steering angle θtgt larger than the second guide steering angle θg2 is acquired.

That is, when the current-location curvature ρnow is equal to or less than the predetermined curvature threshold (that is, the first curvature threshold ρth1), the second guide steering angle θg2 corrected by the cant correction steering angle θc is set as the target guide steering angle θtgt. Then, the target guide steering angle θtgt is used to determine the magnitude of the steering reaction force. Therefore, when the current-location curvature ρnow is equal to or less than the predetermined curvature threshold (that is, the first curvature threshold ρth1), the vehicle driving assistance apparatus 10 performs correction of the steering reaction force based on the cant value CV.

Further, when the entry-predicted curved road CR is a road curving leftward and the cant correction steering angle θc acquired at the step S315 corresponds to a left-downward cross-sloped road, the cant correction steering angle θc acquired at the step S315 functions such that the target guide steering angle θtgt smaller than the second guide steering angle θg2 is acquired.

That is, when the current-location curvature ρnow is equal to or less than the predetermined curvature threshold (that is, the first curvature threshold ρth1), the second guide steering angle θg2 corrected by the cant correction steering angle θc is set as the target guide steering angle θtgt. Then, the target guide steering angle θtgt is used to determine the magnitude of the steering reaction force. Therefore, when the current-location curvature ρnow is equal to or less than the predetermined curvature threshold (that is, the first curvature threshold ρth1), the vehicle driving assistance apparatus 10 performs correction of the steering reaction force based on the cant value CV.

On the other hand, when the entry-predicted curved road CR is a road curving leftward and the cant correction steering angle θc acquired at the step S315 corresponds to a right-downward cross-sloped road, the cant correction steering angle θc acquired at the step S315 functions such that the target guide steering angle θtgt larger than the second guide steering angle θg2 is acquired.

That is, when the current-location curvature ρnow is equal to or less than the predetermined curvature threshold (that is, the first curvature threshold ρth1), the second guide steering angle θg2 corrected by the cant correction steering angle θc is set as the target guide steering angle θtgt. Then, the target guide steering angle θtgt is used to determine the magnitude of the steering reaction force. Therefore, when the current-location curvature ρnow is equal to or less than the predetermined curvature threshold (that is, the first curvature threshold ρth1), the vehicle driving assistance apparatus 10 performs correction of the steering reaction force based on the cant value CV.

Further, when the vehicle driving assistance apparatus 10 proceeds with the process to the step S325 via the step S260 and the step S315, the vehicle driving assistance apparatus 10 acquires, as the target guide steering angle θtgt, a value obtained by adding the cant correction steering angle θc acquired at the step S315 to the guide steering angle θg set at the step S260 (θtgt=θg+θc). Here, the guide steering angle θg set at the step S260 is zero. Therefore, the vehicle driving assistance apparatus 10 acquires the cant correction steering angle θc acquired at the step S315 as the target guide steering angle θtgt.

Further, when the vehicle driving assistance apparatus 10 proceeds with the process to the step S325 via the step S235 and the step S320, the vehicle driving assistance apparatus 10 acquires, as the target guide steering angle θtgt, a value obtained by adding the cant correction steering angle θc set at the step S320 to the first guide steering angle θg1 acquired at the step S235 (θtgt=θg1+θc). Here, the cant correction steering angle θc set at the step S320 is zero. Therefore, the vehicle driving assistance apparatus 10 acquires the first guide steering angle θg1 acquired at the step S235 as the target guide steering angle θtgt.

That is, when the current-location curvature ρnow is greater than a predetermined curvature threshold (that is, the first curvature threshold ρth1), the first guide steering angle θg1 not corrected by the cant correction steering angle θc is set as the target guide steering angle θtgt. Then, the target guide steering angle θtgt is used to determine the magnitude of the steering reaction force. Therefore, when the current-location curvature ρnow is greater than the predetermined curvature threshold (that is, the first curvature threshold ρth1), the vehicle driving assistance apparatus 10 is configured not to perform correction of the steering reaction force based on the cant value CV.

Further, when the vehicle driving assistance apparatus 10 proceeds with the process to the step S325 via the step S255 and the step S320, the vehicle driving assistance apparatus 10 acquires, as the target guide steering angle θtgt, a value obtained by adding the cant correction steering angle θc set at the step S320 to the second guide steering angle θg2 acquired at the step S255 (θtgt=θg2+θc). Here, the cant correction steering angle θc set at the step S320 is zero. Therefore, the vehicle driving assistance apparatus 10 acquires the second guide steering angle θg2 acquired at the step S255 as the target guide steering angle θtgt.

That is, when the current-location curvature ρnow is greater than the predetermined curvature threshold (that is, the first curvature threshold ρth1), the second guide steering angle θg2 not corrected by the cant correction steering angle θc is set as the target guide steering angle θtgt. Then, the target guide steering angle θtgt is used to determine the magnitude of the steering reaction force. Therefore, when the current-location curvature ρnow is greater than the predetermined curvature threshold (that is, the first curvature threshold ρth1), the vehicle driving assistance apparatus 10 is configured not to perform correction of the steering reaction force based on the cant value CV.

Further, when the vehicle driving assistance apparatus 10 proceeds with the process to the step S325 via the step S260 and the step S320, the vehicle driving assistance apparatus 10 acquires, as the target guide steering angle θtgt, a value obtained by adding the cant correction steering angle θc set at the step S320 to the guide steering angle θg set at the step S260 (θtgt=θg+θc). Here, both the guide steering angle θg set at the step S260 and the cant correction steering angle θc set at the step S320 are zero. Therefore, the vehicle driving assistance apparatus 10 sets the target guide steering angle θtgt to zero.

Next, the vehicle driving assistance apparatus 10 proceeds with the process to a step S330 to acquire a steering angle difference Δθ. The vehicle driving assistance apparatus 10 acquires, as the steering angle difference Δθ, a value obtained by subtracting the actual steering angle θact from the target guide steering angle θtgt acquired at the step S325 (Δθ=θtgt−θact).

Next, the vehicle driving assistance apparatus 10 proceeds with the process to a step S335 to acquire a target steering reaction force Ftgt. The vehicle driving assistance apparatus 10 sets the target steering reaction force Ftgt to a smaller value as the steering angle difference Δθ acquired at the step S330 becomes larger.

More specifically, when the steering angle difference Δθ acquired at the step S330 is greater than zero, the target steering reaction force Ftgt becomes a value smaller than a reference steering reaction force FB. On the other hand, when the steering angle difference Δθ acquired at the step S330 is smaller than zero, the target steering reaction force Ftgt becomes a value larger than the reference steering reaction force FB. Further, when the steering angle difference Δθ acquired at the step S330 is zero, the target steering reaction force Ftgt becomes a value equal to the reference steering reaction force FB.

It should be noted that the reference steering reaction force FB is predetermined as the steering reaction force to be applied to the steering wheel 31 when the steering angle difference Δθ is zero.

Next, the vehicle driving assistance apparatus 10 proceeds with the process to a step S340 to control an operation of the reaction force actuator 22 such that a steering reaction force corresponding to the target steering reaction force Ftgt acquired at the step S335 is applied to the steering wheel 31. Next, the vehicle driving assistance apparatus 10 proceeds with the process to a step S395 to terminate the process of this routine once.

It should be noted that, when the entry-predicted curved road CR is a road curving rightward, the counterclockwise steering reaction force FL corresponding to the target steering reaction force Ftgt is applied to the steering wheel 31 by the process at the step S340. On the other hand, when the entry-predicted curved road CR is a road curving leftward, the clockwise steering reaction force FR corresponding to the target steering reaction force Ftgt is applied to the steering wheel 31 by the process at the step S340.

In this manner, the vehicle driving assistance apparatus 10 is configured to control the steering reaction force given to a steering operation performed by the driver.

Further, the vehicle driving assistance apparatus 10 is configured to perform correction of the steering reaction force based on the cant value CV when the current-location curvature ρnow is equal to or less than a predetermined curvature threshold (that is, the first curvature threshold ρth1). On the other hand, the vehicle driving assistance apparatus 10 is configured not to perform correction of the steering reaction force based on the cant value CV when the current-location curvature ρnow is greater than the predetermined curvature threshold (that is, the first curvature threshold ρth1).

The above is the operation of the vehicle driving assistance apparatus 10.

In a situation where the acceleration rate sensor 50 for detecting the lateral acceleration rate of the host vehicle 100 is mounted on the host vehicle 100, the acceleration rate (that is, the lateral acceleration rate Gy) detected by the acceleration rate sensor 50 becomes large when the host vehicle 100 is traveling on a road provided with a cant. Therefore, the magnitude of the cant can be detected based on the acceleration rate detected by the acceleration rate sensor 50.

However, even when the host vehicle 100 is traveling on a road on which a cant is not provided, if the road is a curved road, the acceleration rate detected by the acceleration rate sensor 50 becomes large. At this time, when the magnitude of the cant is detected based on the acceleration rate detected by the acceleration rate sensor 50 and the steering operation is assisted based on the detected magnitude of the cant, there is a possibility that inappropriate assistance is performed.

According to the vehicle driving assistance apparatus 10, when the current-location curvature ρnow is greater than the predetermined curvature threshold (that is, the first curvature threshold ρth1), correction of the steering reaction force based on the cant value CV is not performed. Therefore, steering assistance based on the magnitude of the cant provided on the road can be appropriately performed.

It should be noted that the present invention is not limited to the above-described embodiment, and various modifications can be adopted within the scope of the present invention.

What is claimed is:

1. A vehicle driving assistance apparatus comprising an electronic control unit that controls a steering reaction force given to a steering operation performed by an operator of a host vehicle,
wherein the electronic control unit is configured to:
detect a cant value representing a magnitude of a cant provided on a host vehicle traveling road that is a road on which the host vehicle is traveling, and detect a current-location curvature that is a curvature of the host vehicle traveling road;
perform correction of the steering reaction force based on the cant value when the current-location curvature is equal to or less than a predetermined curvature threshold; and
not perform the correction of the steering reaction force based on the cant value when the current-location curvature is greater than the predetermined curvature threshold.

2. The vehicle driving assistance apparatus according to claim 1,
wherein the host vehicle is equipped with an acceleration rate sensor used to detect a lateral acceleration rate of the host vehicle, and
wherein the electronic control unit is configured to detect the cant value based on the acceleration rate detected by the acceleration rate sensor.

3. A vehicle driving assistance method of controlling a steering reaction force given to a steering operation performed by an operator of a host vehicle,
wherein the vehicle driving assistance method comprises steps of:
detecting a cant value representing a magnitude of a cant provided on a host vehicle traveling road that is a road on which the host vehicle is traveling, and detecting a current-location curvature that is a curvature of the host vehicle traveling road;
performing correction of the steering reaction force based on the cant value when the current-location curvature is equal to or less than a predetermined curvature threshold; and
not performing the correction of the steering reaction force based on the cant value when the current-location curvature is greater than the predetermined curvature threshold.

4. A computer-readable non-transitory storage medium storing a vehicle driving assistance program which controls a steering reaction force given to a steering operation performed by an operator of a host vehicle,
wherein the vehicle driving assistance program is configured to:
detect a cant value representing a magnitude of a cant provided on a host vehicle traveling road that is a road on which the host vehicle is traveling, and detect a current-location curvature that is a curvature of the host vehicle traveling road;
perform correction of the steering reaction force based on the cant value when the current-location curvature is equal to or less than a predetermined curvature threshold; and
not perform the correction of the steering reaction force based on the cant value when the current-location curvature is greater than the predetermined curvature threshold.
